(19) United States
(12) Patent Application Publication
(10) Pub. No.: US 2025/0029299 A1
(43) Pub. Date: Jan. 23, 2025

(54) EFFECT DISPLAY METHOD AND APPARATUS, DEVICE, AND STORAGE MEDIUM

(71) Applicant: Beijing Bytedance Network Technology Co., Ltd., Beijing (CN)

(72) Inventors: Yang LV, Beijing (CN); Ruifeng MA, Beijing (CN)

(21) Appl. No.: 18/715,071

(22) PCT Filed: Nov. 28, 2022
(86) PCT No.: PCT/CN2022/134637

§ 371 Date: May 30, 2024

(30) Foreign Application Priority Data
Nov. 30, 2021 (CN) 202111446912.8

(51) Int. Cl. G06T 11/60

(52) U.S. Cl. CPC G06T 11/60

(57) ABSTRACT

The present disclosure provides an effect display method and apparatus, a device, and a storage medium. The effect display method includes: periodically sending, by a control thread, an effect data request to a preview thread, where the control thread contains at least one effect control; returning, by the preview thread, at least one piece of effect data to the control thread according to the data request; and rendering, by the control thread, the at least one piece of effect data to obtain at least one intermediate effect image, and displaying the at least one intermediate effect image.

The present application claims priority to Chinese Patent Application No. 202111446912.8, filed with the China National Intellectual Property Administration on Nov. 30, 2021, which is incorporated herein by reference in its entirety.

### TECHNICAL FIELD

The present disclosure relates to the field of computer technologies, and for example, to an effect display method and apparatus, a device, and a storage medium.

### BACKGROUND ART

When an intelligent terminal is used to take photos, the photographing effect based on a conventional feature can be achieved by using built-in camera software at the factory, and further, the photographing effect based on an additional feature can be achieved by using an application (APP) downloaded from a network side. For example, various effects for images may be achieved, such as sticker effects, filter effects, and deform effects.

Users are no longer satisfied with a single effect, and therefore a combined effect has won the favor of the users. In the related art, when developing a combined effect package, developers can only view a final effect image of the combined effect package, and cannot see any intermediate effect, which may affect the effect of the combined effect package.

### SUMMARY OF THE INVENTION

The present disclosure provides an effect display method and apparatus, a device, and a storage medium, which may display an intermediate effect in a combined effect package, so that a development user may adjust the intermediate effect, thereby improving the effect of the combined effect package.

According to a first aspect, the present disclosure provides an effect display method. The method includes:
periodically sending, by a control thread, an effect data request to a preview thread, where the control thread contains at least one effect control;
returning, by the preview thread, at least one piece of effect data to the control thread according to the data request; and
rendering, by the control thread, the at least one piece of effect data to obtain at least one intermediate effect image, and displaying the at least one intermediate effect image.

According to a second aspect, the present disclosure further provides an effect display apparatus. The apparatus includes:
an effect data request sending module configured to periodically send, by a control thread, an effect data request to a preview thread, where the control thread contains at least one effect control;
an effect data return module configured to return, by the preview thread, at least one piece of effect data to the control thread according to the data request; and
an intermediate effect obtaining module configured to render, by the control thread, the at least one piece of effect data to obtain at least one intermediate effect image, and display the at least one intermediate effect image.

According to a third aspect, the present disclosure further provides an electronic device. The electronic device includes:
one or more processing apparatuses; and
a storage apparatus configured to store one or more programs, where
the one or more programs, when executed by the one or more processing apparatuses, cause the one or more processing apparatuses to implement the effect display method as described above.

According to a fourth aspect, the present disclosure provides a computer-readable medium having a computer program stored thereon, where the program, when executed by a processing apparatus, causes the effect display method as described above to be implemented.

### BRIEF DESCRIPTION OF DRAWINGS

FIG. 1 is a flowchart of an effect display method according to an embodiment of the present disclosure;

FIG. 2 is a diagram of an example of displaying intermediate effect images according to an embodiment of the present disclosure;

FIG. 3 is a schematic diagram of a structure of an effect display apparatus according to an embodiment of the present disclosure; and

FIG. 4 is a schematic diagram of a structure of an electronic device according to an embodiment of the present disclosure.

### DETAILED DESCRIPTION OF THE INVENTION

Embodiments of the present disclosure are described below with reference to the accompanying drawings. Although some embodiments of the present disclosure are shown in the accompanying drawings, the present disclosure may be implemented in various forms, and these embodiments are provided for understanding the present disclosure. The accompanying drawings and the embodiments of the present disclosure are for exemplary purposes only.

Various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below.

The concepts such as “first” and “second” mentioned in the present disclosure are only used to distinguish different apparatuses, modules, or units, and are not used to limit the sequence of functions performed by these apparatuses, modules, or units or interdependence.

The modifiers “one” and “a plurality of” mentioned in the present disclosure are illustrative and not restrictive, and those skilled in the art should understand that unless the context indicates otherwise, the modifiers should be understood as “one or more”.

The names of messages or information exchanged between a plurality of apparatuses in the implementations of the present disclosure are used for illustrative purposes only, and are not used to limit the scope of these messages or information.

A general effect panel (Effect Graph) in a node system may perform effect processing on one or more pictures.

A plurality of controls in the Effect Graph are connected, which may allow convenient configuration of effect information (material) and mesh information (mesh), while maintaining ordering relations to ensure proper execution of each control. The Effect Graph includes several core functional controls, namely, an effect control, an image input control (including a built-in image input control and a static image input control) and a scene output control, and other extended functional controls.

The core of the Effect Graph is the effect control. Each effect control may be configured with a pair of material and mesh for performing effect rendering on pictures. Each effect control has an output, which is an effect picture. Such an output of the effect control may be an output to the scene output control, or to a next effect control. Each effect control may accept a single or multiple inputs, which may be a built-in image, or an effect picture output by another effect control, or a static image. Such images may be set in the material held by the effect control for use during rendering. If an effect picture output by a current effect control is connected to the scene output control, it indicates that a rendering result of the current effect control may be observed in a scene.

FIG. 1 is a flowchart of an effect display method according to an embodiment of the present disclosure. This embodiment is applicable to displaying an intermediate effect image. The method may be performed by an effect display apparatus. The apparatus may be composed of hardware and/or software, and may generally be integrated in a device having an effect display function. The device may be an electronic device such as a server, a mobile terminal, or a server cluster. As shown in FIG. 1, the method includes the following steps.

Step 110: Periodically send, by a control thread, an effect data request to a preview thread.

The control thread contains at least one effect control, and other functional components, such as an image input control and a scene output control, that are configured to generate an image effect package. The image input control is configured to input a picture for subsequent effect processing. The effect control may function to add an effect to the input image. Effect information and mesh information may be set in the effect control. The effect information may be an effect (such as mirroring, or denoising) added by the effect control to an image to be processed. The mesh information may be a size and a location of the effect added by the effect control to the image to be processed. In addition, the mesh information may contain coordinates of vertices, normal information, etc. of meshes. For example, the mesh information may be a full-screen quadrangle, which indicates effect processing on the whole picture. The scene output control is configured to display a picture obtained after effect processing.

The preview thread is configured to load a plurality of functional controls to obtain effect data output by at least one effect control and final effect data for an effect package. The effect data may be data corresponding to an effect picture, which may be obtained by rendering the effect data.

The effect data request carries an effect data identity document (ID). In this embodiment, the effect data output by each effect control carries an ID.

In this embodiment, before the periodically sending, by a control thread, an effect data request to a preview thread, the method further includes the following steps: starting the control thread and the preview thread; creating, in the control thread, an image input control, at least one effect control, and a scene output control through a creation operation triggered by a user; connecting the image input control, the at least one effect control, and the scene output control in sequence through a connection operation, triggered by the user, according to a set rule; and sending, by the control thread, a load instruction to the preview thread, such that the preview thread loads the at least one effect control to obtain at least one piece of effect data.

The set rule may include the following: the image input control is a start node; the effect control is an intermediate node; the scene output control is an end node; an input to the effect control is not null; and connections between effect controls do not form a closed loop. In this embodiment, the effect control includes one or more inputs and an output. The input of the effect control is connected to an output of the image input control or an output of another effect control. The output of the effect control is connected to an input of another effect control or an input of the scene output control.

After the user starts the node system, the system starts the control thread and the preview thread. In the control thread, the user opens an “Add control” menu by right-clicking a mouse. The menu contains the image input control, the effect controls with various functions, and the scene output control. The user selects these functional controls to create the functional controls. The image input control, at least one effect control, and the scene output control are connected in sequence through a connection operation, triggered by the user, according to a set rule. After detecting that a plurality of functional controls in the control thread are connected, the preview thread begins to load the plurality of functional controls to obtain the effect data output by the at least one effect control.

Step 120: Return, by the preview thread, at least one piece of effect data to the control thread according to the data request.

After receiving the effect data request, the preview thread returns the effect data corresponding to an effect data ID to the control thread.

Step 130: Render, by the control thread, the at least one piece of effect data to obtain at least one intermediate effect image, and display the at least one intermediate effect image.

The intermediate effect image may be displayed in a drop-down interface of a corresponding effect control, and the user may expand and display, or hide the intermediate effect image by clicking an “Expand/Hide” button. After receiving the at least one piece of effect data returned by the preview thread, the control thread renders each of the at least one piece of effect data, and displays the intermediate effect image obtained through the rendering in the drop-down interface of the corresponding effect control.

The effect data may be image data obtained after being processed by the effect control. Each piece of effect data carries an ID which represents an effect control corresponding to the effect data. After receiving the effect data returned by the preview thread, the control thread sends each piece of effect data, according to the ID of the effect data, to the corresponding effect control for rendering in a display area of the effect control, thereby displaying the intermediate effect image processed by each effect control. In this embodiment, display of the intermediate effect image may allow the user to intuitively view the intermediate effect image obtained after being processed by each effect control, thereby facilitating the user to dynamically adjust the effect program file of each effect control based on the viewed effect image, which causes the output of the effect control more in line with the user's needs.

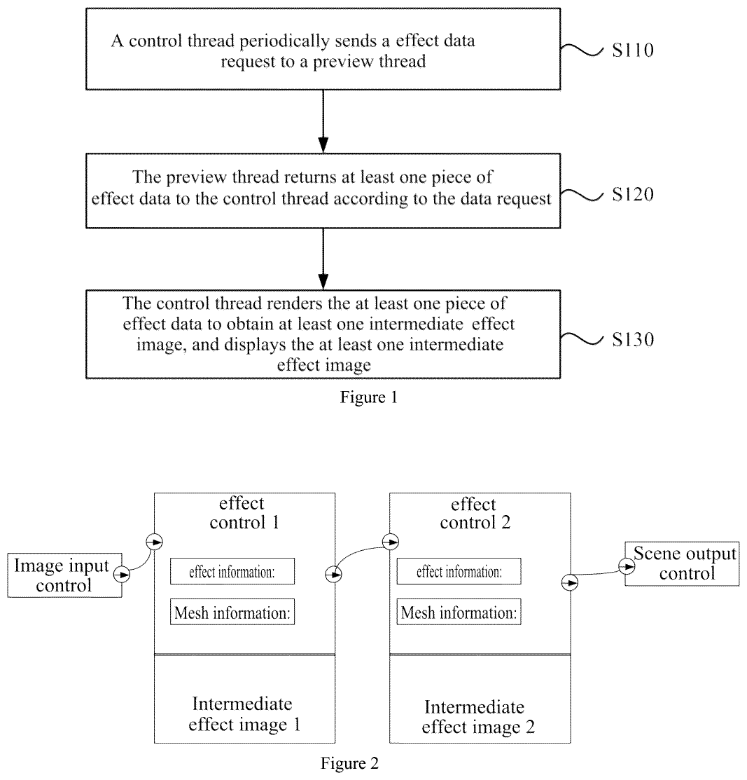

As an example, FIG. 2 is a diagram of an example of displaying intermediate effect images according to an embodiment of the present disclosure. As shown in FIG. 2, after receiving effect data 1 output by an effect control 1 and effect data 2 output by an effect control 2, which are returned by a preview thread, a control thread renders each of the effect data 1 and the effect data 2 to obtain an intermediate effect image 1 and an intermediate effect image 2, and finally, displays the intermediate effect image 1 in a drop-down interface of the effect control 1, and the intermediate effect image 2 in a drop-down interface of the effect control 1.

In this embodiment, the effect control is configured with effect resources, and the effect resources are obtained by loading an effect program file. The effect program file may be a file in any format supported by the node system, for example, a shade file having an extension of “.mshader”. A custom feature program file contains configuration information, general parameter information, and shading information. The general (uniform) parameters may include a rendering order, an output length, width, and angle of a picture, etc. The shading information may be information of a color in which each pixel is shaded, and may include vertex shading information and fragment shading information.

The effect display method provided in this embodiment further includes the following steps: in response to detect that the effect program file is modified, reloading, by the control thread, the modified effect program file to obtain new effect resources; and sending, by the control thread, a reload instruction to the preview thread, such that the preview thread reloads the at least one effect control based on the new effect resources, to obtain at least one piece of new effect data.

When the user needs to modify an effect corresponding to an effect control, the user opens, in a set editor, an effect program file corresponding to the effect control, and modifies the general parameter information and/or the shading information in the effect program file.

Reloading, by the control thread, the modified effect program file may include: reparsing, by the control thread, the modified effect program file; and constructing the new effect resources according to a parsing result.

The process of parsing the effect program file may be a process of parsing program code in the effect program file. Reloading of the at least one effect control by the preview thread may ensure that the effect data in the preview thread is updated with the update of the effect program file, thus ensuring the update of the intermediate effect image.

In an embodiment, after the at least one piece of new effect data is obtained, the method further includes the following steps: periodically sending, by a control thread, an effect data request to a preview thread; returning, by the preview thread, at least one piece of new effect data to the control thread according to the data request; and rendering, by the control thread, the at least one piece of new effect data to obtain at least one new intermediate effect image, and displaying the at least one new intermediate effect image. The benefit of this is that the updated intermediate effect image may be displayed in real time, thereby facilitating the user to modify the effect program file based on the displayed intermediate effect image, to improve the effect of the effect package.

In the technical solution of this embodiment of the present disclosure, the control thread periodically sends the effect data request to the preview thread, where the control thread contains at least one effect control; the preview thread returns at least one piece of effect data to the control thread according to the data request; and the control thread renders the at least one piece of effect data to obtain at least one intermediate effect image, and displays the at least one intermediate effect image. According to the effect display method provided in this embodiment of the present disclosure, the intermediate effect in the combined effect package can be displayed by requesting the effect data from the preview thread to obtain and display the intermediate effect image, so that a development user may adjust the intermediate effect, thereby improving the effect of the combined effect package.

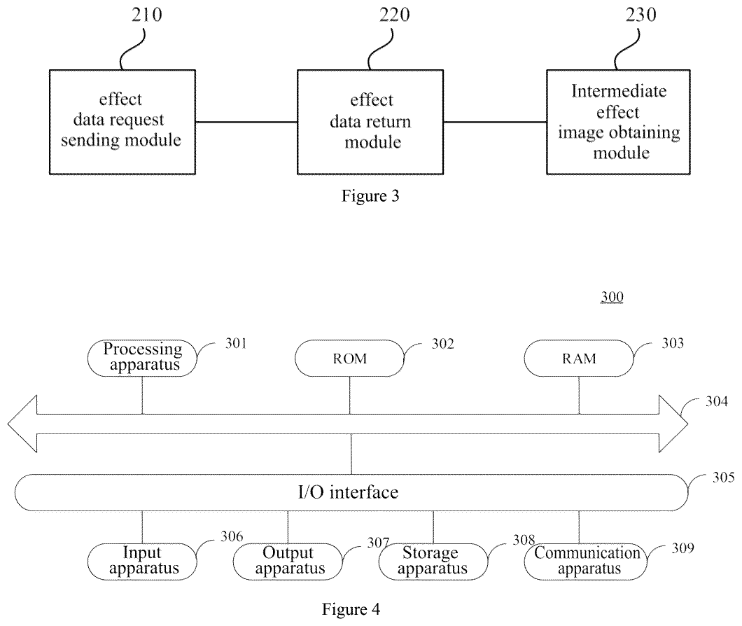

FIG. 3 is a schematic diagram of a structure of an effect display apparatus according to an embodiment of the present disclosure. As shown in FIG. 3, the apparatus includes: an effect data request sending module 210 configured to periodically send, by a control thread, an effect data request to a preview thread, where the control thread contains at least one effect control; an effect data return module 220 configured to return, by the preview thread, at least one piece of effect data to the control thread according to the data request; and an intermediate effect image obtaining module 230 configured to render, by the control thread, the at least one piece of effect data to obtain at least one intermediate effect image, and display the at least one intermediate effect image.

In an embodiment, the effect control is configured with effect resources, and the effect resources are obtained by loading an effect program file.

In an embodiment, the apparatus further includes a new effect resource obtaining module configured to:
in response to detect that the effect program file is modified, reload, by the control thread, the modified effect program file to obtain new effect resources; and send, by the control thread, a reload instruction to the preview thread, such that the preview thread reloads the at least one effect control based on the new effect resources, to obtain at least one piece of new effect data.

In an embodiment, the effect program file includes configuration information, general parameter information, and shading information; and the new effect resource obtaining module is configured to detect that the effect program file is modified by:
detecting that the general parameter information and/or the shading information are/is modified.

In an embodiment, the new effect resource obtaining module is configured to reload the modified effect program file by:
reparsing, by the control thread, the modified effect program file; and constructing the new effect resources according to a parsing result.

In an embodiment, the apparatus further includes a new intermediate effect image display module configured to:
periodically send, by a control thread, an effect data request to a preview thread, return, by the preview thread, at least one piece of new effect data to the control thread according to the data request; and render, by the control thread, the at least one piece of new effect data to obtain at least one new intermediate effect image, and display the at least one new intermediate effect image.

In an embodiment, the apparatus further includes a thread start module configured to: start the control thread and the preview thread; create, in the control thread, an image input control, at least one effect control, and a scene output control through a creation operation triggered by a user; connect the image input control, the at least one effect control, and the scene output control in sequence through a connection operation, triggered by the user, according to a set rule; and send, by the control thread, a load instruction to the preview thread, such that the preview thread loads the at least one effect control to obtain at least one piece of effect data.

The apparatus described above can perform the method provided in all the foregoing embodiments of the present disclosure, and has corresponding functional modules and effects for performing the method described above. For the technical details not described in detail in this embodiment, reference may be made to the method provided in all the above embodiments of the present disclosure.

Reference is made to FIG. 4 below, which is a schematic diagram of a structure of an electronic device 300 suitable for implementing the embodiments of the present disclosure. The electronic device 300 in this embodiment of the present disclosure may include, but is not limited to, mobile terminals such as a mobile phone, a notebook computer, a digital broadcast receiver, a personal digital assistant (PDA), a tablet computer (Portable Android Device, PAD), a portable multimedia player (PMP), and a vehicle-mounted terminal (such as a vehicle navigation terminal), and fixed terminals such as a digital television (TV) and a desktop computer, or various forms of servers such as a separate server or a server cluster. The electronic device 300 shown in FIG. 4 is merely an example, and shall not impose any limitation on the function and scope of use of the embodiments of the present disclosure.

As shown in FIG. 4, the electronic device 300 may include a processing apparatus (e.g., a central processing unit, a graphics processing unit, etc.) 301 that may perform a variety of appropriate actions and processing in accordance with a program stored in a read-only memory (ROM) 302 or a program loaded from a storage apparatus 308 into a random access memory (RAM) 303. The RAM 303 further stores various programs and data required for the operation of the electronic device 300. The processing apparatus 301, the ROM 302, and the RAM 303 are connected to each other through a bus 304. An input/output (I/O) interface 305 is also connected to the bus 304.

Generally, the following apparatuses may be connected to the I/O interface 305: an input apparatus 306 including, for example, a touch screen, a touchpad, a keyboard, a mouse, a camera, a microphone, an accelerometer, and a gyroscope; an output apparatus 307 including, for example, a liquid crystal display (LCD), a speaker, a vibrator, etc.; a storage apparatus 308 including, for example, a tape and a hard disk; and a communication apparatus 309. The communication apparatus 309 may allow the electronic device 300 to perform wireless or wired communication with other devices to exchange data. Although FIG. 4 shows the electronic device 300 having various apparatuses, it is not required to implement or have all of the shown apparatuses. It may be an alternative to implement or have more or fewer apparatuses.

According to an embodiment of the present disclosure, the process described above with reference to the flowcharts may be implemented as a computer software program. For example, this embodiment of the present disclosure includes a computer program product, which includes a computer program carried on a computer-readable medium, where the computer program includes program code for performing the effect display method. In such an embodiment, the computer program may be downloaded from a network through the communication apparatus 309 and installed, installed from the storage apparatus 308, or installed from the ROM 302. When the computer program is executed by the processing apparatus 301, the above-mentioned functions defined in the method of the embodiment of the present disclosure are performed.

The above computer-readable medium described in the present disclosure may be a computer-readable signal medium, or a computer-readable storage medium, or any combination thereof. The computer-readable storage medium may be, for example but not limited to, electric, magnetic, optical, electromagnetic, infrared, or semiconductor systems, apparatuses, or devices, or any combination thereof. Examples of the computer-readable storage medium may include, but are not limited to: an electrical connection having one or more wires, a portable computer magnetic disk, a hard disk, a RAM, a ROM, an erasable programmable read-only memory (EPROM) or a flash memory, an optical fiber, a portable compact disc read-only memory (CD-ROM), an optical storage device, a magnetic storage device, or any suitable combination thereof. In the present disclosure, the computer-readable storage medium may be any tangible medium containing or storing a program which may be used by or in combination with an instruction execution system, apparatus, or device. In the present disclosure, the computer-readable signal medium may include a data signal propagated in a baseband or as a part of a carrier, the data signal carrying computer-readable program code. The propagated data signal may be in various forms, including but not limited to an electromagnetic signal, an optical signal, or any suitable combination thereof. The computer-readable signal medium may also be any computer-readable medium other than the computer-readable storage medium. The computer-readable signal medium can send, propagate, or transmit a program used by or in combination with an instruction execution system, apparatus, or device. The program code contained in the computer-readable medium may be transmitted by any suitable medium, including but not limited to: electric wires, optical cables, radio frequency (RF), etc., or any suitable combination thereof.

In some implementations, a client and a server can communicate using any currently known or future-developed network protocol such as a HyperText Transfer Protocol (HTTP), and may be connected to digital data communication (for example, communication network) in any form or medium. Examples of the communication network include a local area network (LAN), a wide area network (WAN), an internetwork (for example, the Internet), a peer-to-peer network (for example, an ad hoc peer-to-peer network), and any currently known or future-developed network.

The above computer-readable medium may be contained in the above electronic device. Alternatively, the computer-readable medium may exist independently, without being assembled into the electronic device.

The above computer-readable medium carries one or more programs that, when executed by the electronic device, cause the electronic device to: periodically send, by a control thread, an effect data request to a preview thread, where the control thread contains at least one effect control; return, by the preview thread, at least one piece of effect data to the control thread according to the data request; and render, by the control thread, the at least one piece of effect data to obtain at least one intermediate effect image, and display the at least one intermediate effect image.

Computer program code for performing operations of the present disclosure can be written in one or more programming languages or a combination thereof, where the programming languages include but are not limited to object-oriented programming languages, such as Java, Smalltalk, and C++, and further include conventional procedural programming languages, such as “C” language or similar programming languages. The program code may be completely executed on a computer of a user, partially executed on a computer of a user, executed as an independent software package, partially executed on a computer of a user and partially executed on a remote computer, or completely executed on a remote computer or server. In the circumstance involving a remote computer, the remote computer may be connected to a computer of a user over any type of network, including LAN or WAN, or may be connected to an external computer (for example, connected over the Internet using an Internet service provider).

The flowcharts and block diagrams in the accompanying drawings illustrate the possibly implemented architecture, functions, and operations of the system, method, and computer program product according to multiple embodiments of the present disclosure. In this regard, each block in the flowchart or block diagram may represent a module, program segment, or part of code, and the module, program segment, or part of code contains one or more executable instructions for implementing the specified logical functions. It should also be noted that, in some alternative implementations, the functions marked in the blocks may also occur in an order different from that marked in the accompanying drawings. For example, two blocks shown in succession can actually be performed substantially in parallel, or they can sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The related units described in the embodiments of the present disclosure may be implemented by means of software, or may be implemented by means of hardware. The name of a unit does not constitute a limitation on the unit itself under a circumstance.

The functions described herein above may be performed at least partially by one or more hardware logic components. For example, without limitation, exemplary types of hardware logic components that may be used include: a field programmable gate array (FPGA), an application-specific integrated circuit (ASIC), application-specific standard parts (ASSP), a system-on-chip (SOC) system, a complex programming logic device (CPLD), and the like.

In the context of the present disclosure, a machine-readable medium may be a tangible medium that may contain or store a program used by or in combination with an instruction execution system, apparatus, or device. A machine-readable medium may be a machine-readable signal medium or a machine-readable storage medium. A machine-readable medium may include, but is not limited to, electronic, magnetic, optical, electromagnetic, infrared, or semiconductor systems, apparatus, or devices, or any suitable combination thereof. Examples of the machine-readable storage medium may include an electrical connection based on one or more wires, a portable computer disk, a hard disk, a RAM, a ROM, an EPROM or a flash memory, an optical fiber, a CD-ROM, an optical storage device, a magnetic storage device, or any suitable combination thereof.

According to one or more of the embodiments of the present disclosure, the embodiment of the present disclosure discloses an effect display method. The method includes:
periodically sending, by a control thread, an effect data request to a preview thread, where the control thread contains at least one effect control;
returning, by the preview thread, at least one piece of effect data to the control thread according to the data request; and
rendering, by the control thread, the at least one piece of effect data to obtain at least one intermediate effect image, and displaying the at least one intermediate effect image.

According to one or more of the embodiments of the present disclosure, the effect control is configured with effect resources, and the effect resources are obtained by loading an effect program file.

According to one or more of the embodiments of the present disclosure, the method further includes:
in response to detect that the effect program file is modified, reloading, by the control thread,
the modified effect program file to obtain new effect resources; and
sending, by the control thread, a reload instruction to the preview thread, such that the preview thread reloads the at least one effect control based on the new effect resources, to obtain at least one piece of new effect data.

According to one or more of the embodiments of the present disclosure, the effect program file includes configuration information, general parameter information, and shading information; and detecting that the effect program file is modified includes:
detecting that the general parameter information and/or the shading information are/is modified.

According to one or more of the embodiments of the present disclosure, reloading, by the control thread, the modified effect program file includes:
reparsing, by the control thread, the modified effect program file; and
constructing the new effect resources according to a parsing result.

According to one or more of the embodiments of the present disclosure, after the at least one piece of new effect data is obtained, the method further includes:
periodically sending, by a control thread, an effect data request to a preview thread;
returning, by the preview thread, at least one piece of new effect data to the control thread according to the data request; and
rendering, by the control thread, the at least one piece of new effect data to obtain at least one new intermediate effect image, and displaying the at least one new intermediate effect image.

According to one or more of the embodiments of the present disclosure, before the periodically sending, by a control thread, an effect data request to a preview thread, the method further includes:
starting the control thread and the preview thread;
creating, in the control thread, an image input control, at least one effect control, and a scene output control through a creation operation triggered by a user;
connecting the image input control, the at least one effect control, and the scene output control in sequence through a connection operation, triggered by the user, according to a set rule; and sending, by the control thread, a load instruction to the preview thread, such that the preview thread loads the at least one effect control to obtain at least one piece of effect data.

1. A effect display method, comprising:
periodically sending, by a control thread, an effect data request to a preview thread, wherein the control thread contains at least one effect control;
returning, by the preview thread, at least one piece of effect data to the control thread according to the data request; and
rendering, by the control thread, the at least one piece of effect data to obtain at least one intermediate effect image, and displaying the at least one intermediate effect image.

2. The method according to claim 1, wherein the effect control is configured with effect resources, and the effect resources are obtained by loading an effect program file.

3. The method according to claim 2, further comprising:
in response to detect that the effect program file is modified, reloading, by the control thread, the modified effect program file to obtain new effect resources; and
sending, by the control thread, a reload instruction to the preview thread, such that the preview thread reloads the at least one effect control based on the new effect resources, to obtain at least one piece of new effect data.

4. The method according to claim 3, wherein the effect program file comprises configuration information, general parameter information, and shading information; and the detecting that the effect program file is modified comprises:
detecting that at least one of the general parameter information and the shading information is modified.

5. The method according to claim 3, wherein reloading, by the control thread, the modified effect program file comprises:
reparsing, by the control thread, the modified effect program file; and
constructing the new effect resources according to a parsing result.

6. The method according to claim 3, wherein after the at least one piece of new effect data is obtained, the method further comprises:
periodically sending, by the control thread, an effect data request to the preview thread;
returning, by the preview thread, at least one piece of new effect data to the control thread according to the data request; and
rendering, by the control thread, the at least one piece of new effect data to obtain at least one new intermediate effect image, and displaying the at least one new intermediate effect image.

7. The method according to claim 1, wherein before the periodically sending, by a control thread, an effect data request to a preview thread, the method further comprises:
starting the control thread and the preview thread;
creating, in the control thread, an image input control, at least one effect control, and a scene output control through a creation operation triggered by a user;
connecting the image input control, the at least one effect control, and the scene output control in sequence through a connection operation, triggered by the user, according to a set rule; and
sending, by the control thread, a load instruction to the preview thread, such that the preview thread loads the at least one effect control to obtain at least one piece of effect data.

8. (canceled)

9. An electronic device, comprising:
at least one processing apparatus;
a storage apparatus configured to store at least one program, wherein
the at least one program, when executed by the at least one processing apparatus, causes the at least one processing apparatus to:
periodically send, by a control thread, an effect data request to a preview thread, wherein the control thread contains at least one effect control;
return, by the preview thread, at least one piece of effect data to the control thread according to the data request; and
render, by the control thread, the at least one piece of effect data to obtain at least one intermediate effect image, and displaying the at least one intermediate effect image.

10. A computer-readable medium having a computer program stored thereon, wherein the program, when executed by a processing apparatus, causes the processing apparatus to:
periodically send, by a control thread, an effect data request to a preview thread, wherein the control thread contains at least one effect control:
return, by the preview thread, at least one piece of effect data to the control thread according to the data request; and
render, by the control thread, the at least one piece of effect data to obtain at least one intermediate effect image, and displaying the at least one intermediate effect image.

11. The electronic device according to claim 9, wherein the effect control is configured with effect resources, and the effect resources are obtained by loading an effect program file.

12. The electronic device according to claim 11, wherein the electronic device is further caused to:
in response to detect that the effect program file is modified, reload, by the control thread, the modified effect program file to obtain new effect resources; and
send, by the control thread, a reload instruction to the preview thread, such that the preview thread reloads the at least one effect control based on the new effect resources, to obtain at least one piece of new effect data.

13. The electronic device according to claim 12, wherein the effect program file comprises configuration information, general parameter information, and shading information; and the electronic device is further caused to detect that the effect program file is modified by:
detecting that at least one of the general parameter information and the shading information is modified.

14. The electronic device according to claim 12, wherein reloading, by the control thread, the modified effect program file comprises:
reparsing, by the control thread, the modified effect program file; and
constructing the new effect resources according to a parsing result.

15. The electronic device according to claim 12, wherein after the at least one piece of new effect data is obtained, the electronic device is further caused to:
periodically send, by the control thread, an effect data request to the preview thread;
return, by the preview thread, at least one piece of new effect data to the control thread according to the data request; and
render, by the control thread, the at least one piece of new effect data to obtain at least one new intermediate effect image, and displaying the at least one new intermediate effect image.

16. The electronic device according to claim 9, wherein before the periodically sending, by a control thread, an effect data request to a preview thread, the electronic device is further caused to:
start the control thread and the preview thread;
create, in the control thread, an image input control, at least one effect control, and a scene output control through a creation operation triggered by a user;
connect the image input control, the at least one effect control, and the scene output control in sequence through a connection operation, triggered by the user, according to a set rule; and
send, by the control thread, a load instruction to the preview thread, such that the preview thread loads the at least one effect control to obtain at least one piece of effect data.

17. The computer-readable medium according to claim 10, wherein the effect control is configured with effect resources, and the effect resources are obtained by loading an effect program file.

18. The computer-readable medium according to claim 17, the processing apparatus is further caused to:
in response to detect that the effect program file is modified, reload, by the control thread, the modified effect program file to obtain new effect resources; and
send, by the control thread, a reload instruction to the preview thread, such that the preview thread reloads the at least one effect control based on the new effect resources, to obtain at least one piece of new effect data.

19. The computer-readable medium according to claim 18, wherein the effect program file comprises configuration information, general parameter information, and shading information; and the processing apparatus is further caused to detect that the effect program file is modified by:
detecting that at least one of the general parameter information and the shading information is modified.

20. The computer-readable medium according to claim 18, wherein the processing apparatus is further caused to reload, by the control thread, the modified effect program file by:
reparsing, by the control thread, the modified effect program file; and
constructing the new effect resources according to a parsing result.

21. The computer-readable medium according to claim 18, wherein after the at least one piece of new effect data is obtained, the processing apparatus is further caused to:
periodically send, by the control thread, an effect data request to the preview thread;
return, by the preview thread, at least one piece of new effect data to the control thread according to the data request; and
render, by the control thread, the at least one piece of new effect data to obtain at least one new intermediate effect image, and displaying the at least one new intermediate effect image.
